(19) United States
(12) Patent Application Publication
(10) Pub. No.: US 2026/0288341 A1
(43) Pub. Date: Sep. 24, 2026

(54) STORAGE DEVICE, NON-VOLATILE MEMORY DEVICE, AND STORAGE SYSTEM

(71) Applicant: SAMSUNG ELECTRONICS CO., LTD., Suwon-si (KR)

(72) Inventors: Minjeong HEO, Suwon-si (KR); Takuya FUTATSUYAMA, Suwon-si (KR); Dongku KANG, Suwon-si (KR); Hyunsuk KANG, Suwon-si (KR)

(73) Assignee: SAMSUNG ELECTRONICS CO., LTD., Suwon-si (KR)

(21) Appl. No.: 19/466,938

(22) Filed: Feb. 2, 2026

(30) Foreign Application Priority Data
Mar. 19, 2025 (KR) 10-2025-0035526

(51) Int. Cl. G06F 3/06

(52) U.S. Cl. CPC G06F 3/0613; G06F 3/0659; G06F 3/0688

(57) ABSTRACT

A storage device is provided. The storage device includes a storage controller and a plurality of non-volatile memories, where the storage controller is configured to transfer first logical page data of first page data to the first non-volatile memory through the channel while performing a program operation of page data comprising a plurality of pieces of logical page data, and transfer first logical page data of second page data to the second non-volatile memory through the channel while the first logical page data of the first page data from a cache latch of the first non-volatile memory is being dumped into a data latch of the first non-volatile memory.

### CROSS-REFERENCE TO RELATED APPLICATION

This application is based on and claims priority under 35 U.S.C. § 119 to Korean Patent Application No. 10-2025-0035526, filed on Mar. 19, 2025, in the Korean Intellectual Property Office, the disclosure of which is incorporated by reference herein in its entirety.

### BACKGROUND

This application relates to a memory device, and more particularly, to a storage device, a non-volatile memory device, and an operating method of the non-volatile memory device.

Flash memory, a type of non-volatile memory device, has advantages such as large capacity and low noise, and thus, is widely used as a large-capacity storage medium. The operation speed of one flash memory may be slower than other storage mediums, but a plurality of flash memories may be used in parallel, enhancing operation speed. For example, a solid state drive (SSD) based on flash memory communicates with a plurality of flash memory devices through one channel. SSDs may also enhance program or read operation performance through a plurality of channels. Recently, as interface speed increases, the load of undesired overhead is also increasing. Therefore, various methods, which decrease undesired overhead to enhance the performance of flash memory, are being developed.

### SUMMARY

The present disclosure provides a storage device for reducing undesired overhead, a non-volatile memory device, and an operating method of the non-volatile memory device.

A storage device according to an embodiment includes a storage controller and a plurality of non-volatile memories, the plurality of non-volatile memories include a first non-volatile memory and a second non-volatile memory each connected to the storage controller through channel. The storage controller is configured to transfer first logical page data of first page data to the first non-volatile memory through the channel while performing a program operation of page data including a plurality of pieces of logical page data, and transfer first logical page data of second page data to the second non-volatile memory through the channel while the first logical page data of the first page data from a cache latch of the first non-volatile memory is being dumped into a data latch of the first non-volatile memory.

A non-volatile memory device according to an embodiment includes a plurality of non-volatile memories, the plurality of non-volatile memories include a first non-volatile memory and a second non-volatile memory each connected to a storage controller through channel. The first non-volatile memory is configured to receive first logical page data of first page data from the storage controller through the channel while performing a program operation of page data including a plurality of pieces of logical page data. The second non-volatile memory is configured to receive first logical page data of second page data from the storage controller through the channel while the first logical page data of the first page data from a cache latch of the first non-volatile memory into a data latch of the first non-volatile memory.

A storage system according to an embodiment includes a host configured to output a write request, a storage controller configured to output a write command based on the write request, and a non-volatile memory device including a plurality of non-volatile memories and configured to perform a program operation in response to the write command. The plurality of non-volatile memories include a first non-volatile memory and a second non-volatile memory each connected to the storage controller through one channel. The storage controller is configured to transfer first logical page data of first page data to the first non-volatile memory through the one channel while performing a program operation of page data including a plurality of pieces of logical page data, and transfer first logical page data of second page data to the second non-volatile memory through the channel while the first logical page data of the first page data from a cache latch of the first non-volatile memory is being dumped into a data latch of the first non-volatile memory.

### BRIEF DESCRIPTION OF DRAWINGS

Embodiments will be more clearly understood from the following detailed description taken in conjunction with the accompanying drawings in which:

FIG. 1 is a block diagram illustrating a storage system according to an embodiment;

FIG. 2 is a block diagram illustrating a storage device according to an embodiment;

FIG. 3 is a block diagram illustrating a non-volatile memory NVM11 illustrated in FIG. 2 according to an embodiment;

FIG. 4 is a block diagram illustrating an implementation example of the non-volatile memory NVM11 illustrated in FIG. 3 according to an embodiment;

FIG. 5 is a block diagram illustrating an implementation example of a memory cell plane illustrated in FIG. 4 according to an embodiment;

FIG. 6 illustrates a connection between a memory cell array and a page buffer of FIG. 5 according to an embodiment;

FIG. 7 is a circuit diagram illustrating a page buffer PB according to an embodiment;

FIG. 8 is a diagram illustrating a program operation according to an embodiment;

FIG. 9 is a diagram illustrating a program operation according to an embodiment;

FIG. 10A is a timing diagram of a program operation according to a comparative example, and FIG. 10B is a timing diagram of a program operation according to an embodiment;

FIG. 11 illustrates non-volatile memories performing a program operation, according to an embodiment;

FIG. 12 illustrates non-volatile memories performing a program operation, according to an embodiment;

FIGS. 13A and 13B are timing diagrams illustrating in detail a period tDATA where memory cell planes of a non-volatile memory according to an embodiment sequentially receive logical page data;

FIG. 14A illustrates a timing diagram of a confirm command Confirm CMD according to a comparative example;

FIG. 14B illustrates a timing diagram of a command C/C CMD according to an embodiment; and

FIG. 15 illustrates a system to which a storage device according to an embodiment is applied.

### DETAILED DESCRIPTION OF EMBODIMENTS

Hereinafter, various embodiments will be described in detail with reference to the accompanying drawings. Like reference numerals refer to like elements in the drawings, and their repeated descriptions are omitted.

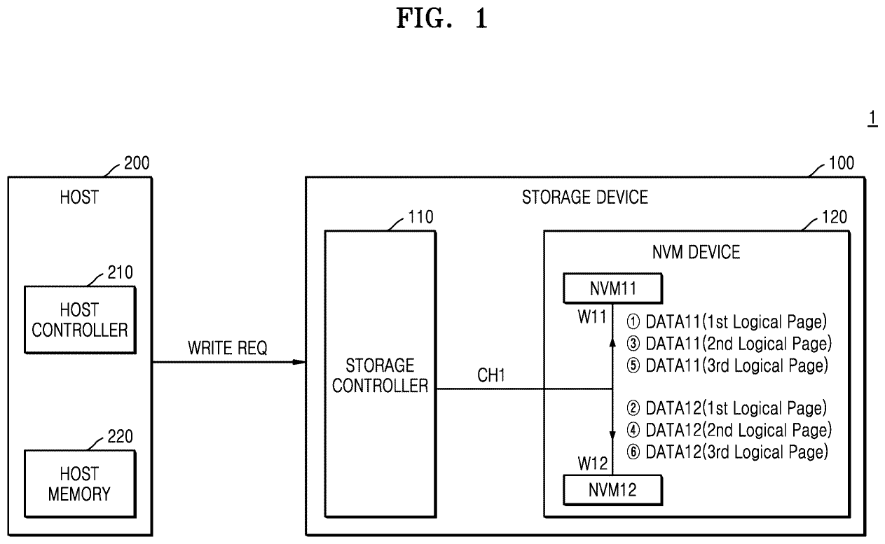

FIG. 1 is a block diagram illustrating a storage system 1 according to an embodiment.

Referring to FIG. 1, the storage system 1 may include a storage device 100 and a host 200, and thus, may be referred to as a host-storage system.

The storage device 100 may include a storage medium for storing data, based on a request from the host 200. For example, the storage device 100 may include at least one of a solid state drive (SSD), an embedded memory, and an attachable/detachable external memory. When the storage device 100 is an SSD, the storage device 100 may be a device conforming with the NVMe standard. When the storage device 100 is an embedded memory or an external memory, the storage device 100 may be a device conforming with the universal flash storage (UFS) or embedded multi-media card (eMMC) standard. Each of the host 200 and the storage device 100 may generate a packet conforming with a suitable standard protocol applied thereto and may transfer the packet.

The host 200 may include a host controller 210 and a host memory 220. The host controller 210 may manage an operation of storing data of a buffer region of the host memory 220 in a non-volatile memory (NVM) device 120, or storing data of the NVM device 120 in the buffer region of the host memory 220. The host memory 220 may function as a buffer memory for temporarily storing write data, which is to be transferred to the storage device 100, or read data transferred from the storage device 100.

For example, the host controller 210 may be one of a plurality of modules included in an application processor, where the application processor may be implemented as a system on chip (SoC). In embodiments, the host memory 220 may be an embedded memory included in the application processor, or may be a non-volatile memory or a memory module disposed outside the application processor.

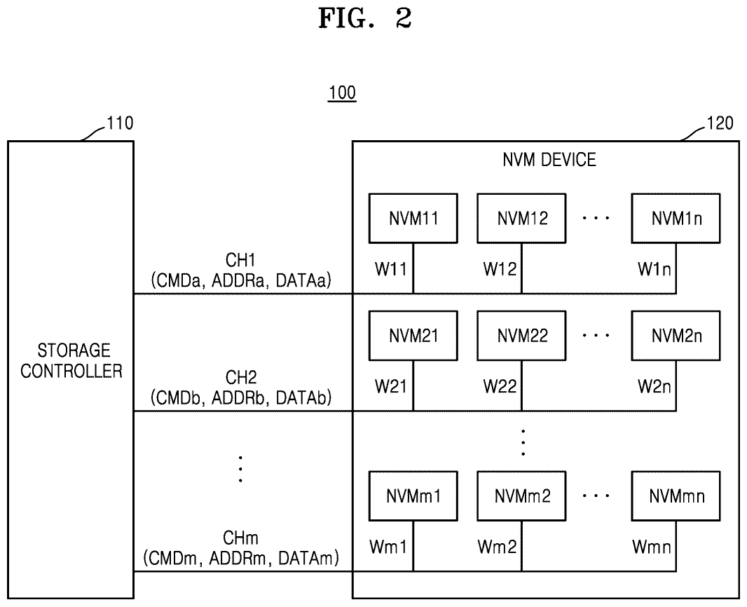

The storage device 100 may include a storage controller 110 and the NVM device 120. According to an embodiment, the storage controller 110 may be referred to as a controller, a memory controller, or a non-volatile memory controller, etc. According to an embodiment, the NVM device 120 may include a plurality of non-volatile memories such as a plurality of memory chips, a plurality of memory dies, or a plurality of memory planes. This will be described below in more detail with reference to FIGS. 2 to 7.

The storage controller 110 may receive a request REQ from the host 200, and in response to the request REQ, the storage controller 110 may control a memory operation on the NVM device 120 and may transfer a response based on the memory operation to the host 200. For example, the memory operation may include a read operation, a program operation, or an erase operation.

The storage controller 110 may be connected to the NVM device 120 through a channel CH. The storage controller 110 may transfer or receive signals to or from the NVM device 120 through the channel CH. For example, the storage controller 110 may transfer a command CMD, an address ADDR, and data DATA to the NVM device 120 through the channel CH, or may receive the data DATA from the NVM device 120.

Referring to FIG. 1, in response to a write request WRITE REQ from the host 200, the storage controller 110 may perform control so that the NVM device 120 performs a program operation on data which is received along with the write request WRITE REQ. The storage controller 110 may be connected to at least two non-volatile memories NVM11 and NVM12 through one channel CH1, and a program operation may denote a triple-level cell (TLC) sequential write operation.

The following embodiments may also be applied to a multi-level cell (MLC) sequential write operation, a quad-level cell (QLC) sequential write operation, and an N-level cell (NLC) (where N may be a positive integer of 5 or more) sequential write operation as well as the TLC sequential write operation. Hereinafter, the TLC sequential write operation will be mainly described.

Referring to FIG. 1, the storage controller 110 may transfer page data DATA11 or DATA12 to the non-volatile memory NVM11 or NVM12 connected to a corresponding way W11 or W12 through one channel CH1.

In the TLC sequential write operation, page data stored in memory cells connected to one word line (WL; FIG. 5) selected as one cell string selection line (SSL; FIG. 5) may include least significant bit (LSB) page data, central significant bit (CSB) page data, and most significant bit (MSB) page data, based on a page type.

Also, each of the LSB page data, the CSB page data, and the MSB page data may be referred to as logical page data. That is, the page data may include a plurality of pieces of logical page data.

Hereinafter, the LSB page data may be referred to as first logical page data (1st Logical Page), the CSB page data may be referred to as second logical page data (2nd Logical Page), and the MSB page data may be referred to as third logical page data (3rd Logical Page).

In a TLC sequential write operation according to a comparative example, a storage controller 110 according to the comparative example may sequentially transfer, to one non-volatile memory, LSB page data (for example, DATA11 (1st Logical Page)), CSB page data (for example, DATA11 (2nd Logical Page)), and MSB page data (for example, DATA11 (3rd Logical Page)) each included in page data (for example, DATA11). That is, the storage controller 110 according to the comparative example may sequentially transfer all of the LSB page data (for example, DATA11 (1st Logical Page)), the CSB page data (for example, DATA11 (2nd Logical Page)), and the MSB page data (for example, DATA11 (3rd Logical Page)), each included in the page data (for example, DATA11), to one non-volatile memory (for example, NVM11) connected to a corresponding way (for example, W11) through an arbitrary channel (for example, CH1), and then, may transfer other page data (for example, DATA12) to another non-volatile memory (for example, NVM12) connected to another way (for example, W12) through the same channel.

In other words, the storage controller 110 and/or the NVM device 120 according to the comparative example may perform an interleave operation by page units including a plurality of logical pages instead of one logical page unit.

On the other hand, referring to FIG. 1, in a TLC sequential write operation according to an embodiment, a storage controller 110 and/or a NVM device 120 according to an embodiment may perform an interleave operation by units of one piece of logical page data.

For example, referring to FIG. 1, the storage controller 110 may transfer a first logical page (DATA11 (1st Logical Page)) of page data DATA11 to a non-volatile memory NVM11 connected to a corresponding way W11 through a channel CH1, and then, may transfer a first logical page (DATA12 (1st Logical Page)) of page data DATA12 to a non-volatile memory NVM12 connected to another way W12 through the same channel. Also, the storage controller 110 may transfer the first logical page (DATA12 (1st Logical Page)) of the page data DATA12 to the non-volatile memory NVM12, and then, may transfer a second logical page (DATA11 (2nd Logical Page)) of the page data DATA11 to the non-volatile memory NVM11. Also, the storage controller 110 may transfer the second logical page (DATA11 (2nd Logical Page)) of the page data DATA11 to the non-volatile memory NVM11, and then, may transfer a second logical page (DATA12 (2nd Logical Page)) of the page data DATA12 to the non-volatile memory NVM12. Also, the storage controller 110 may transfer the second logical page (DATA12 (2nd Logical Page)) of the page data DATA12 to the non-volatile memory NVM12, and then, may transfer a third logical page (DATA11 (3rd Logical Page)) of the page data DATA11 to the non-volatile memory NVM11. Also, the storage controller 110 may transfer the third logical page (DATA11 (3rd Logical Page)) of the page data DATA11 to the non-volatile memory NVM11, and then, may transfer a third logical page (DATA12 (3rd Logical Page)) of the page data DATA12 to the non-volatile memory NVM12.

That is, the storage controller 110 according to the comparative example may perform an interleave operation by page units including a plurality of logical pages, and the storage controller 110 according to an embodiment may perform an interleave operation by units of one piece of logical page data.

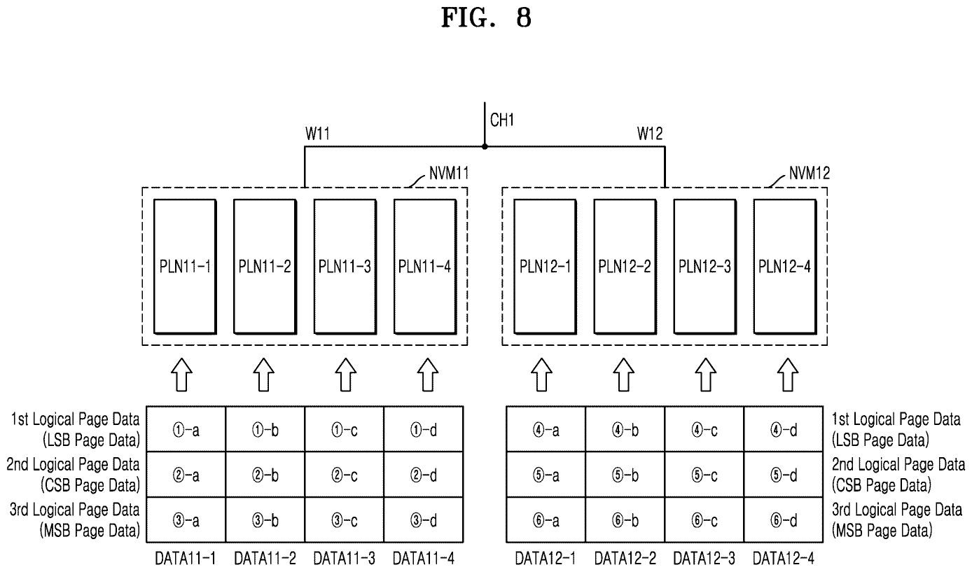

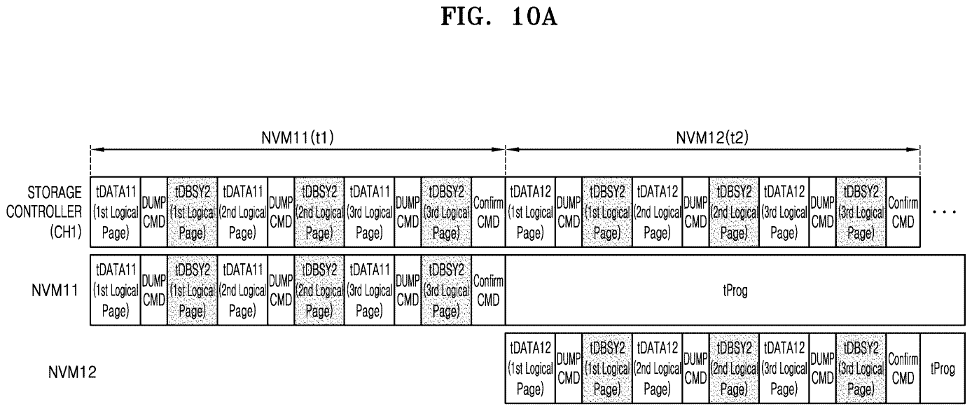

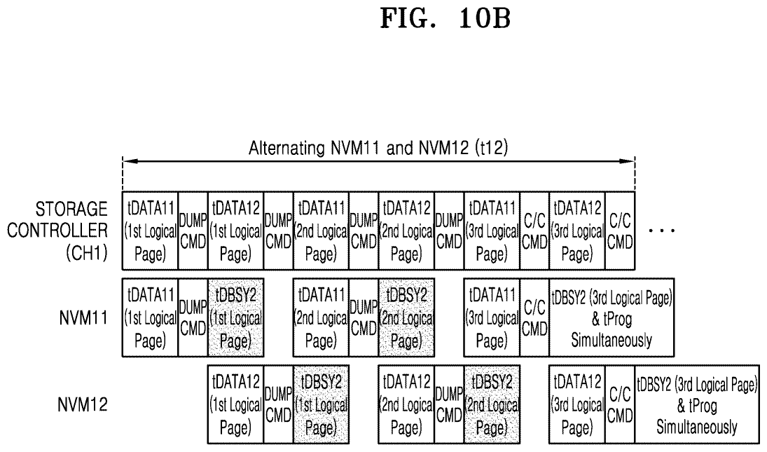

According to an embodiment, the storage controller 110 and/or the NVM device 120 may perform an interleave operation by units of one piece of logical page data. This decreases the undesired overhead (for example, a period tDBSY2 of FIGS. 10A and 10B), and improves input/output efficiency. This will be described below in detail with reference to FIGS. 8 to 14.

FIG. 2 is a block diagram illustrating a storage device 100 according to an embodiment.

Referring to FIG. 2, the storage device 100 may support a plurality of channels CH1 to CHm, and a NVM device 120 and a storage controller 110 may be connected to each other through the plurality of channels CH1 to CHm. The NVM device 120 may include a plurality of non-volatile memories NVM11 to NVMmn. Each of the plurality of non-volatile memories NVM11 to NVMmn may be connected to one of the plurality of channels CH1 to CHm through a corresponding way.

For example, the non-volatile memories NVM11 to NVM1n may be connected to a first channel CH1 through ways W11 to Win, and the non-volatile memories NVM21 to NVM2n may be connected to a second channel CH2 through ways W21 to W2n. In an embodiment, each of the plurality of non-volatile memories NVM11 to NVMmn may be implemented as an arbitrary memory unit capable of operating based on an individual command from the storage controller 110. For example, each of the non-volatile memories NVM11 to NVMmn may be implemented as a chip or a die, but the present disclosure is not limited thereto.

The storage controller 110 may transfer or receive signals to or from the NVM device 120 through the plurality of channels CH1 to CHm. For example, the storage controller 110 may transfer commands CMDa to CMDm, addresses ADDRa to ADDRm, and pieces of data DATAa to DATAm to the NVM device 120 through the channels CH1 to CHm, or may receive the pieces of data DATAa to DATAm from the NVM device 120.

The storage controller 110 may select one non-volatile memory from among the non-volatile memories NVM11 to NVMmn connected to a corresponding channel through each channel and may transfer or receive signals to or from the selected non-volatile memory. For example, the storage controller 110 may select the non-volatile memory NVM11 from among the non-volatile memories NVM11 to NVMmn connected to the first channel CH1. The storage controller 110 may transfer the command CMDa, the address ADDRa, and the data DATAa to the selected non-volatile memory NVM11 through the first channel CH1, or may receive the data DATAa from the selected non-volatile memory NVM11.

The storage controller 110 may transfer or receive signals to or from, through different channels, the NVM device 120 in parallel. For example, the storage controller 110 may transfer the command CMDb to the NVM device 120 through the second channel CH2 in the middle of transferring the command CMDa to the NVM device 120 through the first channel CH1. For example, the storage controller 110 may receive the data DATAb from the NVM device 120 through the second channel CH2 in the middle of receiving the data DATAa from the NVM device 120 through the first channel CH1.

The storage controller 110 may control the overall operation of the NVM device 120. The storage controller 110 may transfer a signal to the channels CH1 to CHm to control each of the non-volatile memories NVM11 to NVMmn connected to the channels CH1 to CHm. For example, the storage controller 110 may transfer the command CMDa and the address ADDRa to the first channel CH1 to control one non-volatile memory selected from among the non-volatile memories NVM11 to NVMmn.

Each of the non-volatile memories NVM11 to NVMmn may operate based on control by the storage controller 110. For example, the non-volatile memory NVM11 may program the data DATAa, based on the command CMDa and the address ADDRa each provided to the first channel CH1. For example, the non-volatile memory NVM21 may read the data DATAb and may transfer the read data DATAb to the storage controller 110, based on the command CMDb and the address ADDRb each provided to the second channel CH2.

In FIG. 2, it is illustrated that the NVM device 120 communicates with the storage controller 110 through m number of channels and includes n number of non-volatile memories, based on each channel, but the number of channels and the number of non-volatile memories connected to one channel may be variously changed according to embodiments.

Furthermore, the storage controller 110 may transfer or receive signals to or from, through different channels, the NVM device 120 in parallel. For example, the storage controller 110 may transfer the command CMDb to the NVM device 120 through the second channel CH2 in the middle of transferring the command CMDa to the NVM device 120 through the first channel CH1. For example, the storage controller 110 may receive the data DATAb from the NVM device 120 through the second channel CH2 in the middle of receiving the data DATAa from the NVM device 120 through the first channel CH1.

Moreover, the storage controller 110 may sequentially transfer or receive signals to or from non-volatile memories connected to a way through one channel. For example, the storage controller 110 may transfer a command CMDa 1 to the non-volatile memory NVM11 connected to the way W11 through the first channel CH1, and then, may transfer a command CMDa_2 to the non-volatile memory NVM12 connected to the way W12 through the first channel CH1. For example, the storage controller 110 may receive a piece of data DATAa 1 from the non-volatile memory NVM11 connected to the way W11 through the first channel CH1, and then, may receive a command DATAa 2 from the non-volatile memory NVM12 connected to the way W12 through the first channel CH1.

That is, the storage controller 110 may not simultaneously transfer or receive signals to or from non-volatile memories connected to different ways through one channel.

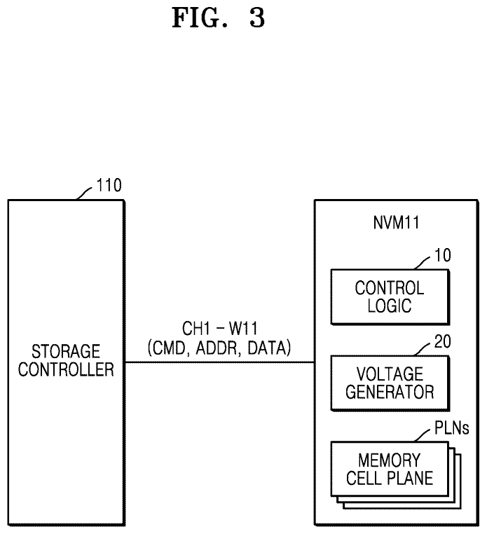

FIG. 3 is a block diagram illustrating the non-volatile memory NVM11 illustrated in FIG. 2.

Each of non-volatile memories NVM11 to NVM1n may have the same configuration. Hereinafter, therefore, a configuration and an operation of a non-volatile memory NVM11 illustrated in FIG. 3 will be described.

Referring to FIG. 3, the non-volatile memory NVM11 may include a plurality of memory cell planes PLNs, a control logic 10, and a voltage generator 20.

The plurality of memory cell planes PLNs may be independent memory cell arrays, respectively. Each of the plurality of memory cell planes PLNs may include a plurality of memory cells, and for example, the plurality of memory cells may be flash memory cells. Hereinafter, a case where a plurality of memory cells are NAND flash memory cells will be described as an example of embodiments. However, the present disclosure is not limited thereto, and in some embodiments, a plurality of memory cells may be resistive memory cells such as resistive random access memory (RAM) (ReRAM), phase change RAM (PRAM), or magnetic RAM (MRAM).

In an embodiment, each of the plurality of memory cell planes PLNs may include a three-dimensional (3D) memory cell array, the 3D memory cell array may include a plurality of NAND strings. Each of the NAND strings may include memory cells which are respectively connected to word lines vertically stacked on a substrate. U.S. Pat. Nos. 7,679,133, 8,553,466, 8,654,587 and 8,559,235 and U.S. Patent Application No. 2011/0233648 discuss elements of a 3D memory array which includes a plurality of levels and in which word lines and/or bit lines are shared between the plurality of levels. In the present specification, the reference documents may be incorporated herein by reference. However, the present disclosure is not limited thereto, and in some embodiments, each of the plurality of memory cell planes PLNs may include a two-dimensional (2D) memory cell array, and the 2D memory cell array may include a plurality of NAND strings which are arranged in a row direction and a column direction.

As a write command requesting a write is provided from the storage controller 110 to the non-volatile memory NVM11, the write operation may be performed based on control by the control logic 10. A write operation may be performed through a plurality of program loops, and a period where the plurality of program loops are performed may be referred to as a program cycle. That is, the operation of writing memory cell data may include a plurality of program loops in a program cycle, and a program operation using a program voltage and a verify operation using one or more verify voltages may be performed in one program loop.

The voltage generator 20 may generate various voltages used in the non-volatile memory NVM11. For example, a program voltage provided to a selected word line and a pass voltage provided to unselected word lines may be generated for a program operation. Also, the voltage generator 20 may further generate a verify voltage and a pass voltage, each used in a verify operation of verifying a program operation, and an erase voltage which is provided to word lines when performing an erase operation. Also, the voltage generator 20 may further generate a string selection voltage provided to string selection lines and a ground selection voltage provided to ground selection lines.

The control logic 10 may control the overall operation of the non-volatile memory NVM11. For example, may output various internal control signals for programming data in each of the plurality of memory cell planes PLNs. The control logic 10 may output various internal control signals for reading data from each of the plurality of memory cell planes PLNs, based on a command CMD, an address ADDR, and a control signal CTRL each received from the storage controller 110. Also, the control logic 10 may output a voltage control signal which adjusts levels of various voltages output from the voltage generator 20, in association with a program operation, a read operation, and an erase operation.

According to an embodiment, the control logic 10 may control program loops that are performed for writing data in each of the plurality of memory cell planes PLNs. For example, the control logic 10 may control program loops, such as, controlling the number of program loops in a program cycle, or adjusting various voltage levels used in a program/verify operation for each of the program loops.

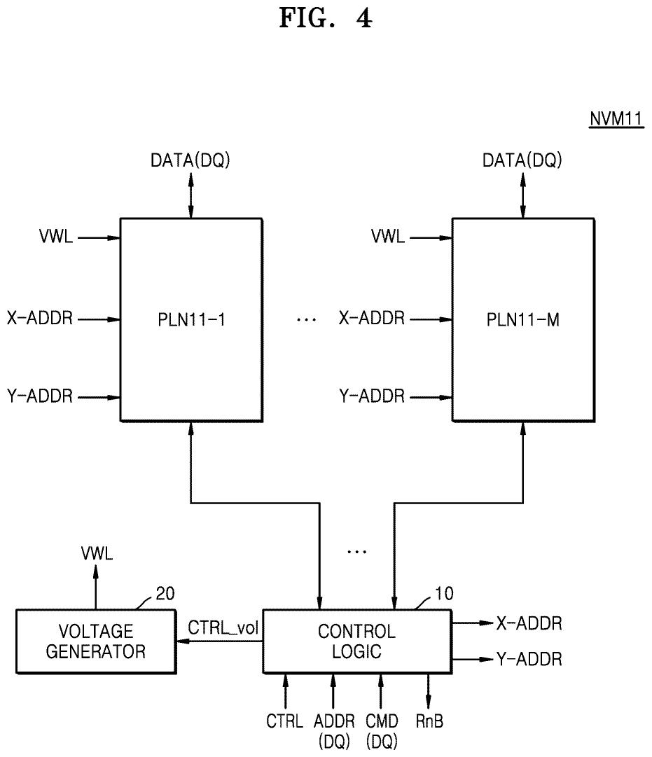

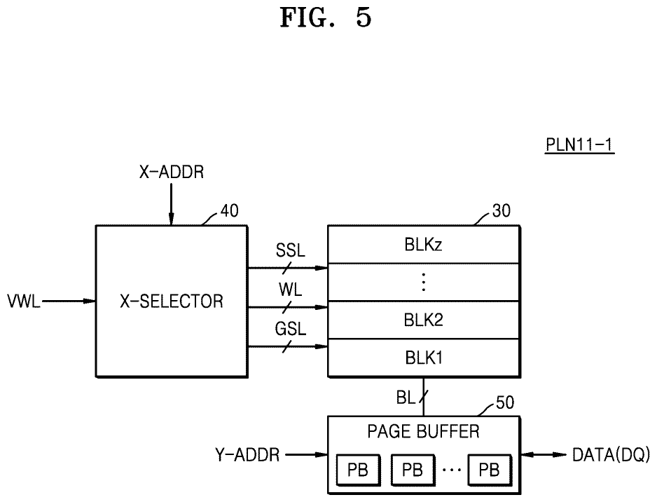

FIG. 4 is a block diagram illustrating an implementation example of the non-volatile memory NVM11 illustrated in FIG. 3.

Referring to FIGS. 3 and 4, the non-volatile memory NVM11 may include first to Mth memory cell planes PLN11-1 to PLN11-M, a control logic 10, and a voltage generator 20. Although not shown in FIG. 2, the non-volatile memory NVM11 may further include other various elements, associated with a memory operation, such as a data input/output (I/O) circuit or an I/O interface. M may be an integer of 1 or more.

The non-volatile memory NVM11 may perform a multi plane program operation.

The control logic 10, based on a command CMD, an address ADDR, and a control signal CTRL each received from a storage controller 110, may program data in each of the first to Mth memory cell planes PLN11-1 to PLN11-M. It may also read data from each of the first to Mth memory cell planes PLN11-1 to PLN11-M. The control logic 10 may output a voltage control signal CTRL_vol for controlling levels of various voltages generated by the voltage generator 20.

For example, the control signal CTRL may include control signals such as a command latch enable signal (CLE), an address latch enable signal (ALE), a write enable signal (WEB), a read enable signal (REB), and a data strobe signal (DQS). Information included in a data signal DQ may be divided into the command CMD, the address ADDR, or data DATA based on the control signal CTRL.

The control logic 10 may provide a row address X-ADDR and a column address Y-ADDR to each of the first to Mth memory cell planes PLN11-1 to PLN11-M. In a program operation, in response to the row address X-ADDR, each of the first to Mth memory cell planes PLN11-1 to PLN11-M may provide a program voltage to a word line of a selected memory cell and/or may provide a pass voltage to word lines of unselected memory cells.

The control logic 10 may enable a ready and busy signal RnB while the non-volatile memory NVM11 is operating. For example, when the ready and busy signal RnB is enabled, the storage controller 110 may not transfer a separate command or data to the non-volatile memory NVM11.

The voltage generator 20 may generate voltages for performing a program operation, a verify operation, a read operation, and an erase operation on each of the first to Mth memory cell planes PLN11-1 to PLN11-M. The voltage generator 20 may generate voltages based on the voltage control signal CTRL_vol. That is, the voltage generator 20 may generate a word line voltage VWL (e.g., the program voltage, the pass voltage, a verify voltage, an erase voltage, or a read voltage). Also, the voltage generator 20 may further generate a string selection line voltage and a ground selection line voltage based on the voltage control signal CTRL_vol.

FIG. 5 is a block diagram illustrating an implementation example of a memory cell plane illustrated in FIG. 4.

Each of first to Mth memory cell planes PLN11-1 to PLN11-M may have the same configuration. Hereinafter, therefore, a configuration and an operation of the first memory cell plane PLN11-1 illustrated in FIG. 5 will be described.

Referring to FIG. 5, the first memory cell plane PLN11-1 according to an embodiment may include a memory cell array 30, a row selection circuit 40 (also referred to as X-ADDR 40), and a page buffer circuit 50 (also referred to as page buffer 50).

The memory cell array 30 may include a plurality of memory blocks BLK1 to BLKz and may be connected to word lines WL, string selection lines SSL, ground selection lines GSL, and bit lines BL. The memory cell array 30 may be connected to a column selection circuit 140 through the word lines WL, the string selection lines SSL, and the ground selection lines GSL. The memory cell array 30 may be connected to the page buffer 50 through the bit lines BL. Each of memory cells may store one or more bits. For example, each memory cell may correspond to an MLC, a TLC, a QLC, or a penta level cell (PLC). However, the present disclosure is not limited thereto, and each memory cell may correspond to a memory cell of a penta level or more. As described above, in the present disclosure, a case where a memory cell is a TLC may be described.

Referring to FIGS. 4 and 5, in response to the row address X-ADDR, the row selection circuit 40 may select one memory block from among a plurality of memory blocks, select one word line WL from among word lines WL of the selected memory block, and select one string selection line SSL from among a plurality of string selection lines SSL.

The page buffer 50 may include page buffers PB. Each of the page buffers PB may be connected to memory cells of the memory cell array 30 through a corresponding bit line. The page buffer 50 may select some bit lines BL from among a plurality of bit lines BL in response to the column address Y-ADDR received from the control logic 10. Each of the page buffers PB may operate as a write driver or a sense amplifier. For example, in a program operation, each of the page buffers PB may apply a voltage, corresponding to data DATA which is to be programmed, to a bit line BL to store the data DATA in a memory cell. As another example, in a program verify operation or a read operation, each of the page buffers PB may sense a current or a voltage through a bit line BL to sense programmed data DATA.

According to embodiments, the page buffers PB may be disposed in a multi-stage structure, and each page buffer PB may have a buffer unit-cache latch split structure where a cache latch and a page buffer unit including a main latch are split and disposed. In the multi-stage structure, a plurality of cache latches arranged in one row may share a combined sensing node. Thus, the page buffer 50 may be implemented in a shared combined sensing node (shared SOC) structure.

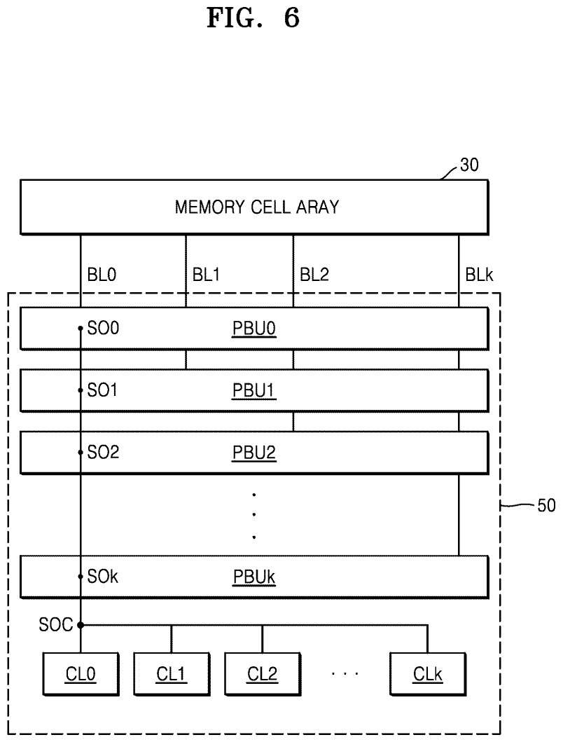

In an embodiment, sensing nodes (for example, SO0 to SOk of FIG. 6) of page buffer units (for example, PBU0 to PBUk of FIG. 6) included in each of the plurality of page buffers PB may be electrically connected to each other through pass transistors. Cache latches (for example, CL0 to CLk of FIG. 6) included in each of the plurality of page buffers PB may be connected to a combined sensing node SOC in parallel. The page buffer units PBU0 to PBUk may respectively correspond to the cache latches CL0 to CLk. For example, the page buffer unit PBU0 may sense data through a bit line BL and may provide sensed data to a corresponding cache latch CL0.

In a sensing operation, the sensing nodes SO0 to SOk of the page buffer units PBU0 to PBUk included in each of the plurality of page buffers PB may be electrically disconnected from one another. In the sensing operation, each of the page buffer units PBU0 to PBUk may sense data through a bit line BL. In the sensing operation, each of the page buffer units PBU0 to PBUk may sense data in parallel.

In a data dumping operation, the page buffer units PBU0 to PBUk may sequentially transfer sensed data to the cache latches CL0 to CLk. In the data dumping operation, a sensing node of a page buffer unit and a combined sensing node connected to a cache latch may be connected to each other.

FIG. 6 illustrates a connection between the memory cell array and the page buffer of FIG. 5, according to an embodiment.

Referring to FIG. 6, a page buffer 50 may include first to kth+1 page buffer units PBU0 to PBUk (where k may be a positive integer). The first page buffer unit PBU0 may be connected to a memory cell array 30 through a first bit line BL0, and the kth+1 page buffer unit PBUk may be connected to the memory cell array 30 through a kth+1 bit line BLk. The page buffer 50 may further include first to kth+1 cache latches CL0 to CLk respectively corresponding to the first to kth+1 page buffer units PBU0 to PBUk. For example, k may be 7, and the page buffer 50 may have a structure where 8-stage page buffer units PBU0 to PBUk and 8-stage cache latches CL0 to CLk are arranged, for example, in one row.

Sensing nodes SO0 to SOk of each of the first to kth+1 page buffer units PBU0 to PBUk may be connected to a combined sensing node SOC in common, and the first to kth+1 cache latches CL0 to CLk may be connected to the combined sensing node SOC in common. Therefore, the first to kth+1 page buffer units PBU0 to PBUk may be connected to the first to kth+1 cache latches CL0 to CLk through the combined sensing node SOC. Although not shown in FIG. 6, the first to kth+1 page buffer units PBU0 to PBUk may include at least one selection transistor which electrically connects the sensing nodes SO0 to SOk with each other.

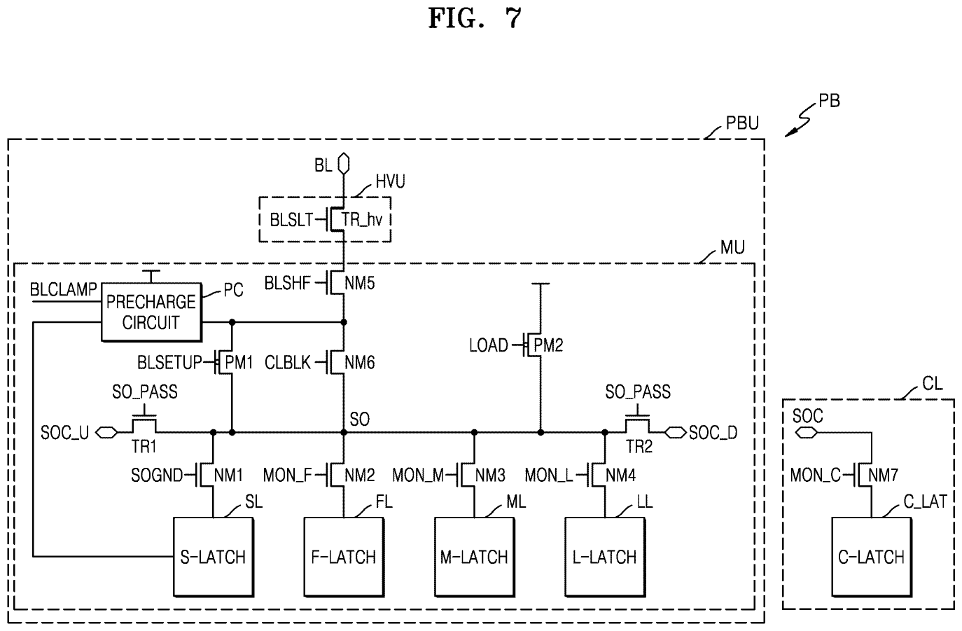

FIG. 7 is a circuit diagram illustrating a page buffer PB according to an embodiment.

Referring to FIG. 7, the page buffer PB may correspond to an example of the page buffer PB of FIG. 5. Also, the sensing node SO may correspond to one of the sensing nodes SO0 to SOk described above with reference to FIG. 6.

The page buffer PB (e.g., page buffer 50) may include a page buffer unit PBU and a cache latch CL. The cache latch CL may be connected to a data I/O line, and thus, the cache latch CL may be disposed adjacent to the data I/O line, but the disclosure is not limited thereto. Therefore, the page buffer unit PBU and the cache latch CL may be disposed apart from each other, and the page buffer PB may have a split structure of page buffer unit PBU-cache latch CL.

Referring to FIG. 7, the cache latch CL may include a latch C_LAT. The page buffer unit PBU may include a main unit MU. The page buffer unit PBU may further include a bit line selection transistor TR_hv, which is connected to a bit line BL and is driven by a bit line selection signal BLSLT. The bit line selection transistor TR_hv may be implemented as a high voltage transistor and may be disposed in a well region (i.e., a high voltage unit HVU) which differs from the main unit MU.

The main unit MU may include a sensing latch SL, a force latch FL, an upper bit latch ML, and a lower bit latch LL. The sensing latch SL, the force latch FL, the upper bit latch ML, or the lower bit latch LL may be referred to as a main latch. A first transistor NM1 may be connected between a sensing node SO and the sensing latch SL and may be driven by a ground control signal SOGND. A second transistor NM2 may be connected between the sensing node SO and the force latch FL and may be driven by a force monitoring signal MON F. A third transistor NM3 may be connected between the sensing node SO and the upper bit latch ML and may be driven by an upper bit monitoring signal MON_M. A fourth transistor NM4 may be connected between the sensing node SO and the lower bit latch LL and may be driven by a lower bit monitoring signal MON_L.

In a read operation or a program verify operation, the sensing latch SL may store data stored in a memory cell or a sensing result of a threshold voltage of the memory cell. Additionally, in a program operation, the sensing latch SL may be used to apply a program bit line voltage or a program prohibit voltage to a bit line BL. The force latch FL may store force data and may be used to improve a threshold voltage distribution in a program operation.

The cache latch CL may receive data, which is read from a memory cell in a read operation, from the sensing latch SL and may output the data to the outside through the data I/O line.

The force latch FL, the upper bit latch ML, the lower bit latch LL, and the cache latch CL may be used to store data input from outside a program operation. The force latch FL, the upper bit latch ML, and the lower bit latch LL may be referred to as a data latch.

In a program operation, the cache latch CL may dump program data, stored in the cache latch CL, into a data latch (for example, one of the force latch FL, the upper bit latch ML, and the lower bit latch LL). That is, in the program operation, the data latch may store the program data transferred from the cache latch CL.

In a TLC sequential write operation according to an embodiment, LSB page data may be dumped from the cache latch CL into the force latch FL, CSB page data may be dumped from the cache latch CL into the lower bit latch LL, and MSB page data may be dumped from the cache latch CL into the upper bit latch ML.

A precharge circuit PC may control a precharge operation on the bit line or the sensing node SO, based on a bit line clamping control signal BLCLAMP. A transistor PM1 may be driven by a bit line setup signal BLSETUP. In embodiments, a transistor NM5 may be driven by a bit line shut-off signal BLSHF, and a transistor NM6 may be driven by a bit line connection control signal CLBLK. A precharge transistor PM2 may be connected to the sensing node SO and may be driven by a load signal LOAD to precharge the sensing node SO in a precharge period.

The main unit MU may further include a pair of pass transistors (i.e., first and second pass transistors) TR1 and TR2 connected to the sensing node SO. The first and second pass transistors TR1 and TR2 may be driven based on a pass control signal SO_PASS. The first pass transistor TR1 may be connected between a first terminal SOC_U and the sensing node SO, and the second pass transistor TR2 may be connected between a second terminal SOC_D and the sensing node SO.

Hereinafter, a program operation according to an embodiment will be described with reference to FIGS. 8 to 10.

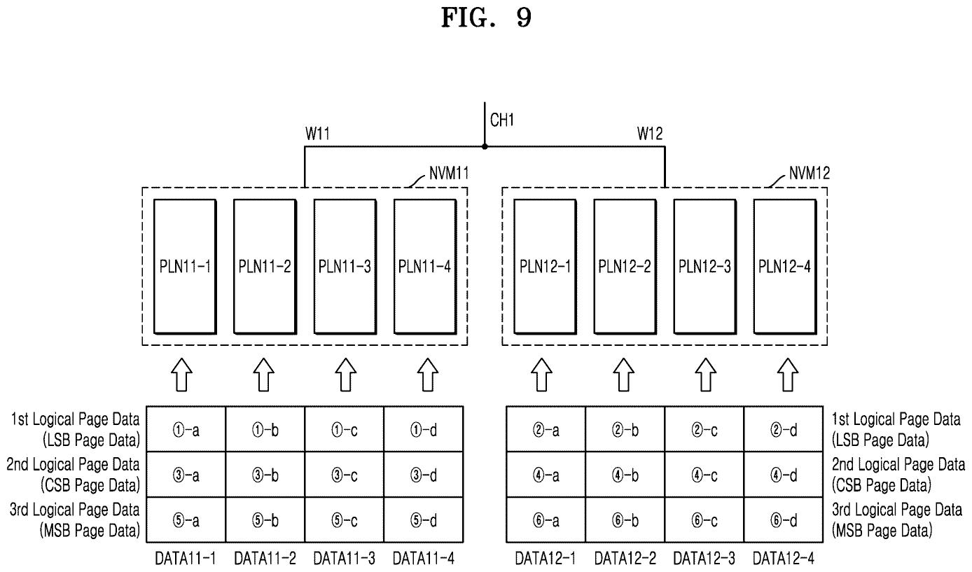

FIG. 8 is a diagram for describing a program operation according to a comparative example. FIG. 9 is a diagram for describing a program operation according to an embodiment. FIG. 10A is a timing diagram of a program operation according to a comparative example, and FIG. 10B is a timing diagram of a program operation according to an embodiment.

Hereinafter, for concise description, a program operation will be described with reference to non-volatile memories NVM11 and NVM12 communicating with a storage controller 110 through a first channel CH1. Also, the non-volatile memories NVM11 and NVM12 may respectively include four memory cell planes PLN11-1 to PLN11-4 and four memory cell planes PLN12-1 to PLN12-4, and each of a plurality of memory cells included in the non-volatile memories NVM11 and NVM12 is a TLC storing 3 bits per cell.

In embodiments, page data DATA11 may include pieces of page data DATA11-1 to DATA11-4 that corresponds to the four memory cell planes PLN11-1 to PLN11-4. Page data DATA12 may include pieces of page data DATA12-1 to DATA12-4 to correspond to the four memory cell planes PLN12-1 to PLN12-4.

Referring to FIG. 8, in a TLC sequential write operation according to a comparative example, a storage controller 110 according to the comparative example may sequentially transfer LSB page data 1, CSB page data 2, and MSB page data 3 constituting page data DATA11 to a non-volatile memory NVM11, and then, may sequentially transfer LSB page data 4, CSB page data 5, and MSB page data 6 constituting page data DATA12 to a non-volatile memory NVM12.

Also, the storage controller 110 according to the comparative example may sequentially transfer page data, corresponding to each piece of logical page data, to memory cell planes. Referring to FIG. 8, when LSB page data is transferred, the storage controller 110 according to the comparative example may transfer page data DATA11-1 corresponding to first logical page data (LSB Page Data) to a memory cell plane PLN11-1 (\textcircled{1}-a), may then transfer page data DATA11-2 corresponding to the first logical page data (LSB Page Data) to a memory cell plane PLN11-2 (\textcircled{1}-b), may then transfer page data DATA11-3 corresponding to the first logical page data (LSB Page Data) to a memory cell plane PLN11-3 (\textcircled{1}-c), and may then transfer page data DATA11-4 corresponding to the first logical page data (LSB Page Data) to a memory cell plane PLN11-4 (\textcircled{1}-d). When CSB page data and MSB page data, like the transfer of the LSB page data, the storage controller 110 according to the comparative example may sequentially transfer corresponding page data to memory cell planes. The case of page data DATA12 may also be similar to the case of the page data DATA11 described above, but the disclosure is not limited thereto.

To summarize, the storage controller 110 according to the comparative example may perform an interleave operation by page units including a plurality of logical pages instead of one logical page units. The interleave operation may denote an operation of programming data in a plurality of non-volatile memories such as a plurality of memory chips, a plurality of memory dies, or a plurality of memory planes in parallel or alternately.

On the other hand, referring to FIG. 9, in a TLC sequential write operation according to an embodiment, a storage controller 110 according to an embodiment may perform an interleave operation by units of one piece of logical page data.

In other words, the storage controller 110 may alternately transfer logical page data to non-volatile memories. Each of the non-volatile memories may temporarily store received corresponding logical page data in a cache latch (for example, C_LAT of FIG. 7) of a corresponding page buffer. Moreover, each of the non-volatile memories may dump data of the cache latch (for example, C_LAT of FIG. 7) into a data latch (for example, one of the force latch FL, the upper bit latch ML, and the lower bit latch LL of FIG. 7) in response to a dump command (for example, DUMP CMD of FIG. 10) received from the storage controller 110.

Referring to FIG. 9, the storage controller 110 may transfer LSB page data constituting page data DATA 11 to non-volatile memory NVM11 (\textcircled{1}), may transfer LSB page data constituting page data DATA 12 to non-volatile memory NVM12 (\textcircled{2}), may transfer CSB page data constituting the page data DATA 11 to the non-volatile memory NVM11 (\textcircled{3}). The storage controller 110 may transfer CSB page data constituting the page data DATA 12 to the non-volatile memory NVM12 (\textcircled{4}), may transfer MSB page data constituting the page data DATA 11 to the non-volatile memory NVM11 (\textcircled{5}), and may transfer MSB page data constituting the page data DATA 12 to the non-volatile memory NVM12 (\textcircled{6}).

Also, the storage controller 110 may sequentially transfer page data, corresponding to each piece of logical page data, to memory cell planes. Referring to FIG. 9, when LSB page data is transferred, the storage controller 110 may transfer page data DATA11-1 corresponding to first logical page data (LSB Page Data) to a memory cell plane PLN11-1 (\textcircled{1}-a), may then transfer page data DATA11-2 corresponding to the first logical page data (LSB Page Data) to a memory cell plane PLN11-2 (\textcircled{1}-b). The storage controller 110 may sequentially transfer page data DATA11-3 corresponding to the first logical page data (LSB Page Data) to a memory cell plane PLN11-3 (\textcircled{1}-c), and may transfer page data DATA11-4 corresponding to the first logical page data (LSB Page Data) to a memory cell plane PLN11-4 (\textcircled{1}-d). When CSB page data and MSB page data, like the transfer of the LSB page data, the storage controller 110 may sequentially transfer corresponding page data to memory cell planes. The case of page data DATA12 may also be similar to the case of the page data DATA11 described above, and thus, its detailed description may be omitted.

According to an embodiment, the storage controller 110 and/or the NVM device 120 may perform an interleave operation by units of one piece of logical page data. This decreases undesired overhead (for example, a period tDBSY2 of FIGS. 10A and 10B), and improves I/O efficiency.

Referring to FIG. 10A, a timing diagram of each of a page data setup period t1 of the non-volatile memory NVM11 according to the comparative example and a page data setup period t2 of the non-volatile memory NVM11 according to the comparative example is illustrated. Referring to FIG. 10B, a timing diagram of a page data setup period t12 of each of the non-volatile memories NVM11 and NVM12 according to an embodiment is illustrated. Also, in FIG. 10A and FIG. 10B, a timing diagram of the storage controller 110 (or a channel CH1), a timing diagram of the non-volatile memory NVM11, and a timing diagram of the non-volatile memory NVM12 are illustrated.

Also, for briefness of the drawings, a standby period tCWAW and an address data loading period tADL between a command and an address each undesired in describing a technical feature of the present disclosure may be omitted in the timing diagrams.

Referring to FIG. 10A, the page data setup period t11 may include a period DATA11 where page data corresponding to each piece of logical page data is sequentially transferred to (or received by) memory cell planes, a period in which a dump command DUMP CMD for each piece of logical page data is transferred (or received), a period tDBSY2 where a dump operation on corresponding logical page data is performed in response to the dump command DUMP CMD, and a period in which a program confirm command Confirm CMD is transferred (or received) so that the non-volatile memory NVM11 performs a program operation. Also, the non-volatile memory NVM11 may perform a program operation in a program period tProg after the page data setup period t11.

Referring to FIGS. 7 and 10A, in a period tDATA11 (1st Logical Page), the storage controller 110 may transfer the LSB page data to the non-volatile memory NVM11, and the non-volatile memory NVM11 may sequentially store the transferred LSB page data in a cache latch C_LAT included in each of memory cell planes of the non-volatile memory NVM11. Subsequently, the storage controller 110 may transfer the dump command DUMP CMD to the non-volatile memory NVM11, and the non-volatile memory NVM11 may receive the dump command DUMP CMD. In a period tDBSY2 (1st Logical Page), the non-volatile memory NVM11 may dump the LSB page data of the cache latch C_LAT, included in each of the memory cell planes of the non-volatile memory NVM11, into a force latch FL included in each of the memory cell planes of the non-volatile memory NVM11.

Referring to FIGS. 7 and 10A, in a period tDATA11 (2nd Logical Page) after the period tDBSY2 (1st Logical Page) ends, the storage controller 110 may transfer the CSB page data to the non-volatile memory NVM11, and the non-volatile memory NVM11 may sequentially store the transferred CSB page data in the cache latch C_LAT included in each of the memory cell planes of the non-volatile memory NVM11. Subsequently, the storage controller 110 may transfer the dump command DUMP CMD to the non-volatile memory NVM11, and the non-volatile memory NVM11 may receive the dump command DUMP CMD. In a period tDBSY2 (2nd Logical Page), the non-volatile memory NVM11 may dump the CSB page data of the cache latch C_LAT, included in each of the memory cell planes of the non-volatile memory NVM11, into a lower bit latch LL included in each of the memory cell planes of the non-volatile memory NVM11.

Referring to FIGS. 7 and 10A, in a period tDATA11 (3rd Logical Page) after the period tDBSY2 (2nd Logical Page) ends, the storage controller 110 may transfer the MSB page data to the non-volatile memory NVM11, and the non-volatile memory NVM11 may sequentially store the transferred MSB page data in the cache latch C_LAT included in each of the memory cell planes of the non-volatile memory NVM11. Subsequently, the storage controller 110 may transfer the dump command DUMP CMD to the non-volatile memory NVM11, and the non-volatile memory NVM11 may receive the dump command DUMP CMD. In a period tDBSY2 (3rd Logical Page), the non-volatile memory NVM11 may dump the MSB page data of the cache latch C_LAT, included in each of the memory cell planes of the non-volatile memory NVM11, into an upper bit latch ML included in each of the memory cell planes of the non-volatile memory NVM11.

Referring to FIGS. 7 and 10A, after the period tDATA11 (3rd Logical Page) ends, the storage controller 110 may transfer a confirm command Confirm CMD to the non-volatile memory NVM11, and the non-volatile memory NVM11 may receive the confirm command Confirm CMD. Subsequently, in a period tProg, the non-volatile memory NVM11 may perform a program operation in response to the confirm command Confirm CMD.

A page data setup period t12 may be similar to the page data setup period t11, and thus, its detailed description may be omitted.

Referring to FIGS. 10A and 10B, according to an embodiment, it may be seen that a period tDBSY2 (1st Logical Page), a period tDBSY2 (2nd Logical Page), and a period tDBSY2 (3rd Logical Page) do not appear in a timing diagram of the storage controller 110 (or channel CH1).

In the comparative example, because the storage controller 110 has to perform the next operation (transfer next page data to a corresponding non-volatile memory or transfer the confirm command Confirm CMD) after a dumping operation (the period tDBSY2 (1st Logical Page), the period tDBSY2 (2nd Logical Page), or the period tDBSY2 (3rd Logical Page)) of page data of a non-volatile memory ends, the delay time caused by the dumping operation (the period tDBSY2 (1st Logical Page), the period tDBSY2 (2nd Logical Page), or the period tDBSY2 (3rd Logical Page)) may occur as undesired overhead.

On the other hand, in embodiments, the storage controller 110 may transfer page data to a different non-volatile memory during a dumping operation (a period tDBSY2 (1st Logical Page), a period tDBSY2 (2nd Logical Page), or a period tDBSY2 (3rd Logical Page)) of page data of a non-volatile memory. This may reduce delay time as the delay time caused by the dumping operation (the period tDBSY2 (1st Logical Page), the period tDBSY2 (2nd Logical Page), or the period tDBSY2 (3rd Logical Page)) may not occur.

In detail, referring to FIG. 7 and FIG. 10B, while the storage controller 110 is transferring the LSB page data to the non-volatile memory NVM12 in a period tDATA12 (1st Logical Page), the non-volatile memory NVM11 may dump the LSB page data of the cache latch C_LAT, included in each of the memory cell planes of the non-volatile memory NVM11, into the force latch FL included in each of the memory cell planes of the non-volatile memory NVM11 in response to the dump command DUMP CMD.

Referring to FIG. 7 and FIG. 10B, while the storage controller 110 is transferring the CSB page data to the non-volatile memory NVM11 in a period tDATA11 (2nd Logical Page), the non-volatile memory NVM12 may dump the CSB page data of the cache latch C_LAT, included in each of the memory cell planes of the non-volatile memory NVM12, into the force latch FL included in each of the memory cell planes of the non-volatile memory NVM12 in response to the dump command DUMP CMD.

Referring to FIG. 7 and FIG. 10B, while the storage controller 110 is transferring the CSB page data to the non-volatile memory NVM12 in a period tDATA12 (2nd Logical Page), the non-volatile memory NVM11 may dump the CSB page data of the cache latch C_LAT, included in each of the memory cell planes of the non-volatile memory NVM11, into the lower bit latch LL included in each of the memory cell planes of the non-volatile memory NVM11 in response to the dump command DUMP CMD.

Referring to FIG. 7 and FIG. 10B, while the storage controller 110 is transferring the MSB page data to the non-volatile memory NVM11 in a period tDATA11 (3rd Logical Page), the non-volatile memory NVM12 may dump the CSB page data of the cache latch C_LAT, included in each of the memory cell planes of the non-volatile memory NVM12, into the lower bit latch LL included in each of the memory cell planes of the non-volatile memory NVM12 in response to the dump command DUMP CMD.

Also, referring to FIG. 7 and FIG. 10B, after the period tDATA11 (3rd Logical Page), the storage controller 110 may transfer a command C/C CMD to the non-volatile memory NVM11. In response to the command C/C CMD, the non-volatile memory NVM11 may start to perform a program operation on the LSB page data, the CSB page data, and the MSB page data while dumping the MSB page data of the cache latch C_LAT, included in each of the memory cell planes of the non-volatile memory NVM11, into the upper bit latch ML included in each of the memory cell planes of the non-volatile memory NVM11.

Likewise, referring to FIG. 7 and FIG. 10B, after the period tDATA12 (3rd Logical Page), the storage controller 110 may transfer a command C/C CMD to the non-volatile memory NVM12. In response to the command C/C CMD, the non-volatile memory NVM12 may start to perform a program operation on the LSB page data, the CSB page data, and the MSB page data while dumping the MSB page data of the cache latch C_LAT, included in each of the memory cell planes of the non-volatile memory NVM12, into the upper bit latch ML included in each of the memory cell planes of the non-volatile memory NVM12.

The command C/C CMD may be a command where the dump command DUMP CMD and the confirm command Confirm CMD are integrated and may instruct a corresponding non-volatile memory to perform a dumping operation and a program operation.

That is, referring to FIG. 10B, based on the command C/C CMD according to an embodiment, the storage controller 110 according to an embodiment may transfer the last logical page (for example, data DATA11 (3rd Logical Page)) to a corresponding non-volatile memory and may perform the next operation (for example, transfer logical page data to a different non-volatile memory) without needing to stand by until a dumping operation of the corresponding non-volatile memory is completed. Referring to FIG. 10B, the storage controller 110 according to the comparative example has to transfer the last logical page (for example, data DATA11 (3rd Logical Page)) and the dump command DUMP CMD, stand by until a dumping operation of a corresponding non-volatile memory is completed, and separately transfer the confirm command Confirm CMD to the corresponding non-volatile memory after the completion.

In other words, based on the command C/C CMD according to an embodiment, the storage controller 110 may allow a program operation of a corresponding non-volatile memory to start and may transfer page data to a different non-volatile memory, in the middle of a dumping operation (period tDBSY2 (3rd Logical Page)) of page data of a non-volatile memory. This reduces delay time as the delay time caused by the dumping operation (period tDBSY2 (3rd Logical Page)) may not occur.

According to embodiments, the order of LSB page data, CSB page data, and MSB page data each input to one non-volatile memory described above with reference to FIG. 10B may differ. For example, in some embodiments, MSB page data, CSB page data, and LSB page data may be input to one non-volatile memory in this stated order. Also, according to embodiments, a dumping target latch of LSB page data, CSB page data, and MSB page data may differ from the description of FIG. 10B. For example, in some embodiments, LSB page data of a cache latch C_LAT may be dumped into a latch which differs from a force latch FL.

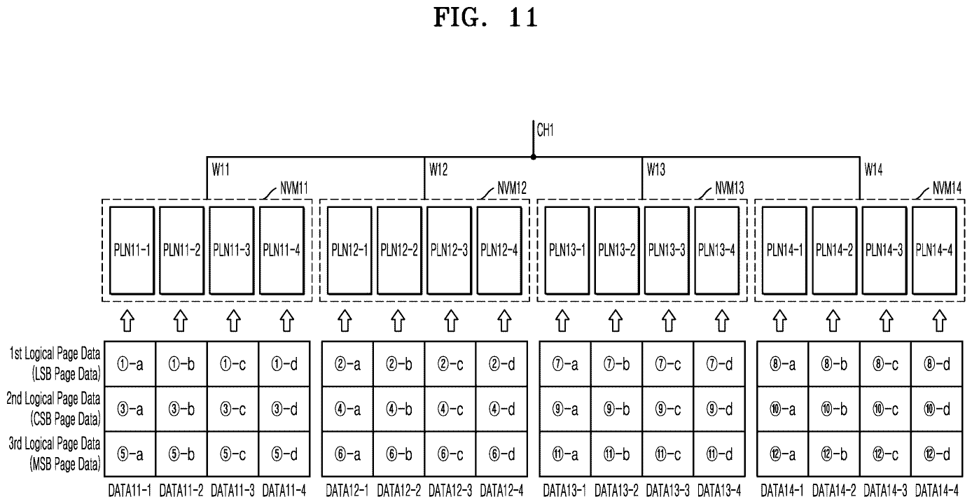

FIG. 11 illustrates non-volatile memories performing a program operation, according to an embodiment.

Referring to FIG. 11, a program operation will be described with reference to non-volatile memories NVM11, NVM12, NVM13, and NVM14 communicating with a storage controller 110 through a first channel CH1. Also, non-volatile memories NVM11, NVM12, NVM13, and NVM14 respectively include four memory cell planes PLN11-1 to PLN11-4, PLN12-1 to PLN12-4, PLN13-1 to PLN13-4, and PLN14-1 to PLN14-4, and each of a plurality of memory cells included in the non-volatile memories NVM11, NVM12, NVM13, and NVM14 is a TLC storing 3 bits per cell.

In embodiments, page data DATA11 may include pieces of page data DATA11-1 to DATA11-4 that corresponds to the four memory cell planes PLN11-1 to PLN11-4. Page data DATA12 may include pieces of page data DATA12-1 to DATA12-4 to correspond to the four memory cell planes PLN12-1 to PLN12-4. Page data DATA13 may include pieces of page data DATA13-1 to DATA13-4 to correspond to the four memory cell planes PLN13-1 to PLN13-4. Page data DATA14 may include pieces of page data DATA14-1 to DATA14-4 to correspond to the four memory cell planes PLN14-1 to PLN14-4.

As described above with reference to FIG. 9 and FIG. 10B, in a TLC sequential write operation according to an embodiment, a storage controller 110 according to an embodiment may perform an interleave operation by units of one piece of logical page data.

Referring to FIG. 10B and FIG. 11, in a program operation of each of pieces of page data DATA11, DATA12, DATA13, and DATA14 including a plurality of pieces of logical page data (LSB page data, CSB page data, and MSB page data), the storage controller 110 may transfer first logical page data (LSB page data) of the page data DATA11 to a non-volatile memory NVM11 through one channel CH1 (\textcircled{1}). The non-volatile memory NVM11 may store the transferred first logical page data (LSB page data) of the page data DATA11 in a cache latch included in the non-volatile memory NVM11.

In detail, referring to FIG. 10B and FIG. 11, the storage controller 110 may sequentially transfer, through one channel CH1, first logical page data (LSB page data) of each of pieces of page data DATA11-1, DATA11-2, DATA11-3, and DATA11-4 to memory cell planes PLN11-1 to PLN11-4 included in the non-volatile memory NVM11 (\textcircled{1}-a, \textcircled{1}-b, \textcircled{1}-c, and \textcircled{1}-d).

Moreover, referring to FIG. 10B and FIG. 11, in response to a dump command DUMP CMD of the storage controller 110, the non-volatile memory NVM11 may dump the first logical page data (LSB page data) of the page data DATA11 from a cache latch, included in the non-volatile memory NVM11, into a data latch included in the non-volatile memory NVM11. While the non-volatile memory NVM11 is dumping the first logical page data (LSB page data) of the page data DATA11 from the cache latch of the non-volatile memory NVM11 into the data latch included in the non-volatile memory NVM11, the storage controller 110 may transfer first logical page data (LSB page data) of the page data DATA12 to a non-volatile memory NVM12 through one channel CH1 (\textcircled{2}). The non-volatile memory NVM12 may store the transferred first logical page data (LSB page data) of the page data DATA12 in a cache latch included in the non-volatile memory NVM12.

In detail, referring to FIG. 10B and FIG. 11, while the memory cell planes PLN11-1 to PLN11-4 of the non-volatile memory NVM11 are dumping first logical page data (LSB page data) of the page data DATA11-1, DATA11-2, DATA11-3, and DATA11-4 from a corresponding cache latch to a corresponding data latch for each of the memory cell planes PLN11-1 to PLN11-4, the storage controller 110 may sequentially transfer, through one channel CH1, first logical page data (LSB page data) of page data DATA12-1, DATA12-2, DATA12-3, and DATA12-4 to memory cell planes PLN12-1 to PLN12-4 included in the non-volatile memory NVM12 (\textcircled{2}-a, \textcircled{2}-b, \textcircled{2}-c, and \textcircled{2}-d).

In some embodiments, referring to FIG. 10B and FIG. 11, in response to a dump command DUMP CMD of the storage controller 110, the non-volatile memory NVM12 may dump the first logical page data (LSB page data) of the page data DATA12 from a cache latch, included in the non-volatile memory NVM12, into a data latch included in the non-volatile memory NVM12. While the non-volatile memory NVM12 is dumping the first logical page data (LSB page data) of the page data DATA12 from the cache latch of the non-volatile memory NVM12 into the data latch included in the non-volatile memory NVM12, the storage controller 110 may transfer second logical page data (CSB page data) of the page data DATA11 to a non-volatile memory NVM12 through one channel CH1 (\textcircled{3}). The non-volatile memory NVM11 may store the transferred second logical page data (CSB page data) of the page data DATA11 in a cache latch included in the non-volatile memory NVM11.

Comparing operations \textcircled{1}, \textcircled{2}, and \textcircled{3}, with operation \textcircled{4}, there may only be a difference in the data latch which is a target of a dump operation, and thus, its detailed operation may be omitted.

In embodiments, referring to FIG. 10B and FIG. 11, after the operation \textcircled{4}, the storage controller 110 may transfer third logical page data (MSB page data) of the page data DATA11 to the non-volatile memory NVM11 through one channel CH1 (\textcircled{5}).

After the third logical page data (MSB page data) of the page data DATA11 is transferred, the storage controller 110 may transfer a command C/C CMD to the non-volatile memory NVM11 through one channel CH1. In response to the command C/C CMD, while the non-volatile memory NVM11 is dumping the third logical page data (MSB page data) of the page data DATA11 from a cache latch of the non-volatile memory NVM11 into a data latch included in the non-volatile memory NVM11, the non-volatile memory NVM11 may start to perform a program operation on the page data DATA11. The storage controller 110 may transfer third logical page data (MSB page data) of the page data DATA12 to the non-volatile memory NVM12 through one channel CH1 (\textcircled{6}).

After the third logical page data (MSB page data) of the page data DATA12 is transferred, the storage controller 110 may transfer a command C/C CMD to the non-volatile memory NVM12 through one channel CH1. In response to the command C/C CMD, while the non-volatile memory NVM12 is dumping the third logical page data (MSB page data) of the page data DATA12 from a cache latch of the non-volatile memory NVM12 into a data latch included in the non-volatile memory NVM12, the non-volatile memory NVM12 may start to perform a program operation on the page data DATA12.

Comparing with the operations \textcircled{1}, \textcircled{2}, \textcircled{3}, \textcircled{4}, \textcircled{5}, and 6̅, operations \textcircled{7}, \textcircled{8}, \textcircled{9}, \textcircled{11}, \textcircled{11}, and \textcircled{12} may differ only in that a target non-volatile memory is a non-volatile memory NVM13 and a non-volatile memory NVM14, and thus, their detailed descriptions may be omitted.

That is, the storage controller 110 illustrated in FIG. 11 may perform an interleave operation by units of one piece of logical page data, based on alternating between the non-volatile memory NVM11 and the non-volatile memory NVM12.

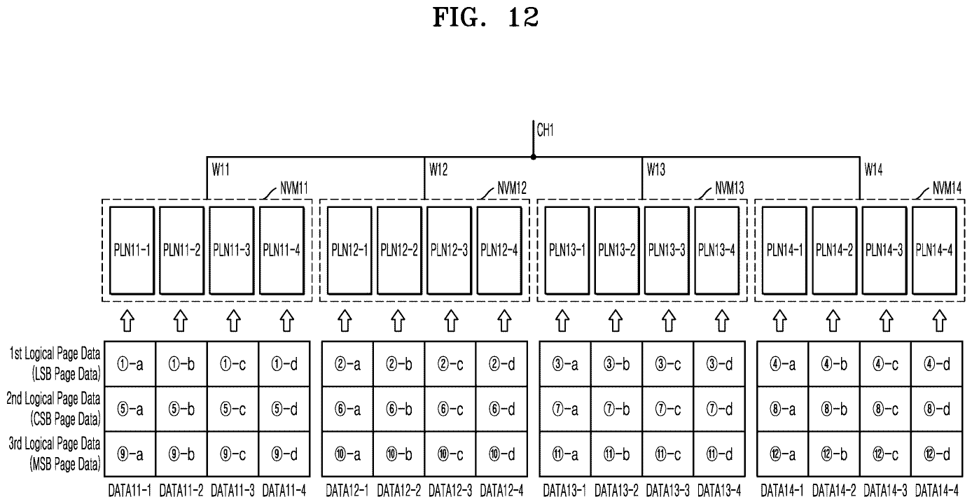

FIG. 12 illustrates non-volatile memories performing a program operation, according to another embodiment.

FIG. 12 may correspond to a modification example of FIG. 11, and thus, a difference there between may be mainly described.

A storage controller 110 illustrated in FIG. 12 may perform an interleave operation by units of one piece of logical page data, based on alternating between a non-volatile memory NVM11, a non-volatile memory NVM12, a non-volatile memory NVM13, and a non-volatile memory NVM14.

In detail, referring to FIG. 12, unlike the embodiment of FIG. 11, while the non-volatile memory NVM12 is dumping first logical page data (LSB page data) of page data DATA12 from a cache latch of the non-volatile memory NVM12 into a data latch included in the non-volatile memory NVM12, the storage controller 110 may transfer first logical page data (LSB page data) of page data DATA13 to the non-volatile memory NVM13 through one channel CH1 (\textcircled{3}). The non-volatile memory NVM13 may store the transferred first logical page data (LSB page data) of the page data DATA13 in a cache latch included in the non-volatile memory NVM13.

Subsequently, referring to FIG. 12, in response to a dump command DUMP CMD of the storage controller 110, the non-volatile memory NVM13 may dump the first logical page data (LSB page data) of the page data DATA13 from the cache latch of the non-volatile memory NVM13 into a data latch included in the non-volatile memory NVM13. While the non-volatile memory NVM13 is dumping the first logical page data (LSB page data) of the page data DATA13 from the cache latch of the non-volatile memory NVM13 into the data latch included in the non-volatile memory NVM11, the storage controller 110 may transfer first logical page data (LSB page data) of the page data DATA14 to the non-volatile memory NVM14 through one channel CH1 (\textcircled{4}). The non-volatile memory NVM14 may store the transferred first logical page data (LSB page data) of the page data DATA14 in a cache latch included in the non-volatile memory NVM14.

Subsequently, referring to FIG. 12, in response to a dump command DUMP CMD of the storage controller 110, the non-volatile memory NVM14 may dump the first logical page data (LSB page data) of the page data DATA14 from the cache latch of the non-volatile memory NVM14 into a data latch included in the non-volatile memory NVM14. While the non-volatile memory NVM14 is dumping the first logical page data (LSB page data) of the page data DATA14 from the cache latch of the non-volatile memory NVM14 into the data latch included in the non-volatile memory NVM14, the storage controller 110 may transfer second logical page data (CSB page data) of the page data DATA11 to the non-volatile memory NVM11 through one channel CH1 (\textcircled{5}). The non-volatile memory NVM11 may store the transferred second logical page data (CSB page data) of the page data DATA11 in a cache latch included in the non-volatile memory NVM11.

Operations \textcircled{6}, \textcircled{7}, and \textcircled{8} subsequent thereto may differ in only data latch which is a target of a dump operation and/or non-volatile memory which is a target of data transfer and may be similar to the operations \textcircled{1}, \textcircled{2}, \textcircled{3}, \textcircled{4}, and \textcircled{5}, and thus, their detailed descriptions may be omitted. Moreover, operations \textcircled{9}, \textcircled{10}, \textcircled{11}, and \textcircled{12} of FIG. 12 may be similar to the operations \textcircled{5} and \textcircled{6} of FIG. 11, and thus, their detailed descriptions may be omitted.

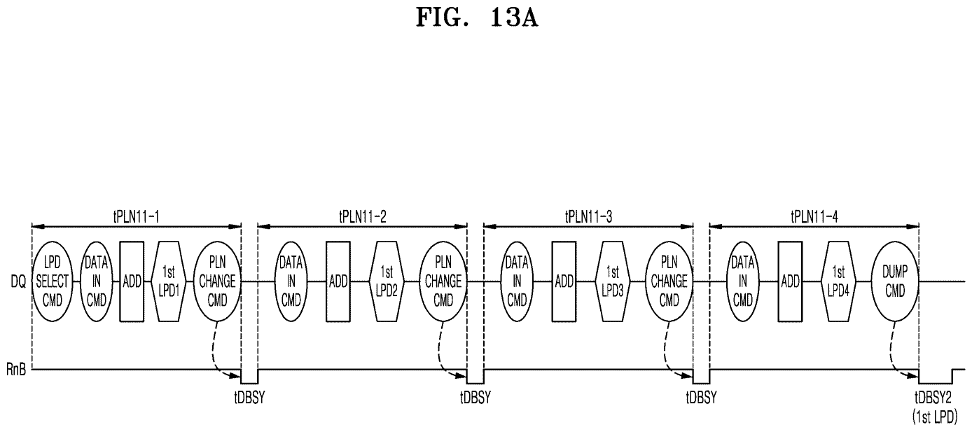

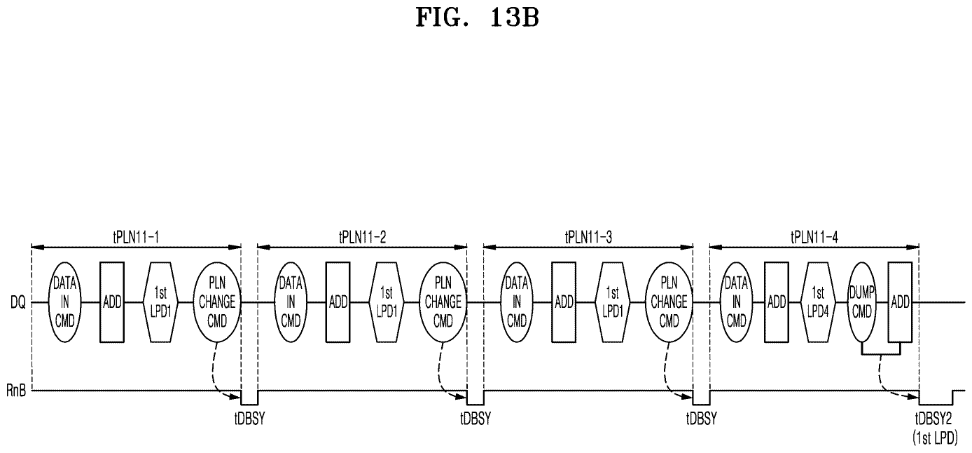

FIGS. 13A and 13B are timing diagrams illustrating in detail a period tDATA where memory cell planes of a non-volatile memory according to an embodiment sequentially receive logical page data.

FIGS. 13A and 13B are timing diagrams illustrating in detail the period tDATA11 (1st Logical Page) described above with reference to FIG. 10B. Descriptions below may all be applied to a period tDATA, where memory cell planes of a non-volatile memory sequentially receive logical page data, such as a period tDATA11 (2nd Logical Page), a period tDATA12 (3rd Logical Page), and a period tDATA12 (1st Logical Page).

Moreover, FIGS. 13A and 13B is a timing diagram illustrating in detail a process where the storage controller 110 described above with reference to FIG. 11 sequentially transfers, through one channel CH1, first logical page data (LSB page data) of each of pieces of page data DATA11-1, DATA11-2, DATA11-3, and DATA11-4 to memory cell planes PLN11-1 to PLN11-4 included in a non-volatile memory NVM11 (\textcircled{1}-a, \textcircled{1}-b, \textcircled{1}-c, and \textcircled{1}-d). The first logical page data (LSB page data) of the page data DATA11-1, DATA11-2, DATA11-3, and DATA11-4 of FIG. 11 may be respectively referred to as page data 1st LPD1, page data 1st LPD2, page data 1st LPD3, and page data 1st LPD4.

Also, a ready and busy signal RnB may be a low level active signal. That is, the ready and busy signal RnB which is logic low may represent a busy state of a non-volatile memory NVM11.

Also, for briefness of the drawings, a standby period tCWAW and an address data loading period tADL between a command and an address each undesired in describing a technical feature of the present disclosure may be omitted in the timing diagrams.

Referring to FIGS. 13A and 13B, a period tDATA may include a period tPLN11-1 where a memory cell plane PLN11-1 operates, a period tPLN11-2 where a memory cell plane PLN11-2 operates, a period tPLN11-3 where a memory cell plane PLN11-3 operates, and a period tPLN11-4 where a memory cell plane PLN11-4 operates.

Referring to FIGS. 13A and 13B, a command DATA IN CMD may be a command which inputs corresponding data to a corresponding memory cell plane. For example, in response to the command DATA IN CMD, the non-volatile memory NVM11 may store corresponding page data in a cache latch included in the memory cell plane PLN11-1. An address ADD after the command DATA IN CMD may be an address indicating a physical position at which corresponding page data is to be stored. A command PLN CHANGE CMD may be a command which changes a target of an operation from a target memory cell plane to another memory cell plane. A dump command DUMP CMD may be a command which instructs to dump page data of a cache latch, included in the memory cell planes PLN11-1 to PLN11-4, into a data latch.

FIGS. 13A and 13B may differ in method which designates a logical page, and as described above, the same address and command may be used. For example, in FIG. 13A, a logical page may be designated by a command LPD SELECT CMD, and in FIG. 13B, a logical page may be designated by an address ADD after the dump command DUMP CMD. In detail, referring to FIG. 13A, the command LPD SELECT CMD may be a command which designates a logical page which is a target of an operation. Referring to FIG. 13B, the address ADD after the dump command DUMP CMD may be an address which designates a logical page which is a target of an operation. For example, the address ADD may designate one of an LSB page, a CSB page, and an MSB page.

Referring to FIG. 13A, in a period tPLN11-1, a non-volatile memory NVM11 may store page data 1st LPD1 in a cache latch corresponding to the memory cell plane PLN11-1 in response to a command DATA IN CMD. Subsequently, the non-volatile memory NVM11 may change a target of an operation to a memory cell plane PLN11-2 for a time tDBSY in response to a command PLN CHANGE CMD. A period tPLN11-2 and a period tPLN11-3 may be similar to the period tPLN11-1, and thus, their detailed descriptions may be omitted.

Referring to FIG. 13A, in a period tPLN11-4, the non-volatile memory NVM11 may store the page data 1st LPD1 in a cache latch corresponding to a memory cell plane PLN11-4 in response to the command DATA IN CMD. Subsequently, the non-volatile memory NVM11 may dump corresponding package data of a cache latch, included in each of memory cell planes PLN11-1 to PLN11-4, into a data latch corresponding to a logical page designated by the command LPD SELECT CMD for a time (period tDBSY2) in response to the dump command DUMP CMD.

Referring to FIG. 13B, in a period tPLN11-1, a non-volatile memory NVM11 may store page data 1st LPD1 in a cache latch corresponding to the memory cell plane PLN11-1 in response to a command DATA IN CMD. Subsequently, the non-volatile memory NVM11 may change a target of an operation to a memory cell plane PLN11-2 for a time tDBSY in response to a command PLN CHANGE CMD. A period tPLN11-2 and a period tPLN11-3 may be similar to the period tPLN11-1, and thus, their detailed descriptions may be omitted.

Referring to FIG. 13B, in a period tPLN11-4, the non-volatile memory NVM11 may store the page data 1st LPD1 in a cache latch corresponding to a memory cell plane PLN11-4 in response to the command DATA IN CMD. Subsequently, the non-volatile memory NVM11 may dump corresponding package data of a cache latch, included in each of memory cell planes PLN11-1 to PLN11-4, into a data latch for a time (period tDBSY2) in response to the dump command DUMP CMD and an address ADD after the dump command DUMP CMD.

In some embodiments, the dump command DUMP CMD and an address ADD after the dump command DUMP CMD may be replaced with one command.

As described above with reference to the preceding drawings, a storage controller 110 may transfer corresponding page data to a non-volatile memory NVM12 for a time (period tDBSY2) where the non-volatile memory NVM11 performs a dump operation.

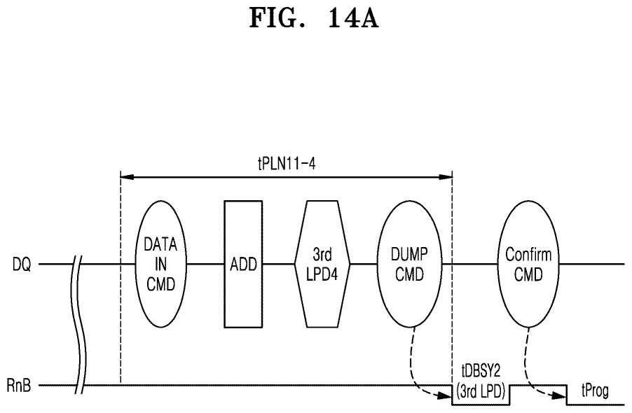

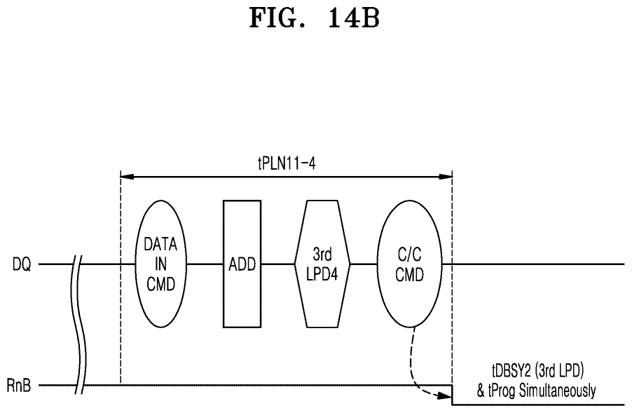

FIG. 14A illustrates a timing diagram of a confirm command Confirm CMD according to a comparative example, and FIG. 14B illustrates a timing diagram of a command C/C CMD according to an embodiment.

FIG. 14A illustrates a timing diagram of a non-volatile memory NVM11 operating on the last logical page in response to the confirm command Confirm CMD according to the comparative example in FIG. 10A, and FIG. 14B illustrates a timing diagram of a non-volatile memory NVM11 operating on the last logical page in response to a command C/C CMD according to an embodiment in FIG. 10B. Descriptions overlapping FIGS. 13A and 13B may be omitted.

Referring to FIG. 14A, in a period tPLN11-4, the non-volatile memory NVM11 may store last page data 3rd LPD4 in a cache latch corresponding to a memory cell plane PLN11-4 in response to a command DATA IN CMD. Subsequently, the non-volatile memory NVM11 may dump corresponding package data of a cache latch, included in each of the memory cell planes PLN11-1 to PLN11-4, into the data latch for a time (period tDBSY2) in response to the dump command DUMP CMD. After the time (period tDBSY2), the non-volatile memory NVM11 may perform a program operation in response to the confirm command Confirm CMD.

Referring to FIG. 14B, in a period tPLN11-4, the non-volatile memory NVM11 may store last page data 3rd LPD4 in a cache latch corresponding to a memory cell plane PLN11-4 in response to a command DATA IN CMD. Subsequently, the non-volatile memory NVM11 may start to perform a program operation on LSB page data, CSB page data, and/or MSB page data while dumping the corresponding package data of the cache latch, included in each of the memory cell planes PLN11-1 to PLN11-4, into the data latch in response to the command C/C CMD.

The command C/C CMD may be a command where the dump command DUMP CMD and the confirm command Confirm CMD are integrated and may instruct a corresponding non-volatile memory to perform a dumping operation and a program operation.

Referring to FIG. 14A, according to an embodiment, a ready and busy signal RnB of the non-volatile memory NVM11 may be enabled once up to an end time of a program operation of page data DATA11 of the non-volatile memory NVM11 from a time at which the non-volatile memory NVM11 receives the command C/C CMD. On the other hand, referring to FIG. 14A, according to the comparative example, as the ready and busy signal RnB is enabled in response to the dump command DUMP CMD, and the ready and busy signal RnB is enabled in response to the confirm command Confirm CMD, the ready and busy signal RnB of the non-volatile memory NVM11 may be enabled total twice up to the end time of the program operation of the page data DATA11 of the non-volatile memory NVM11 from the time at which the non-volatile memory NVM11 receives the command C/C CMD.

Referring to FIG. 14A, according to the comparative example, because the storage controller 110 has to perform the next operation (for example, transfer the confirm command Confirm CMD) after a dumping operation tDBSY2 (3rd LPD) of last logical page data of a non-volatile memory ends, the delay time caused by the dumping operation tDBSY2 (3rd LPD) may occur as undesired overhead.

On the other hand, unlike the comparative example, referring to FIG. 14B, according to an embodiment, the delay time caused by the dumping operation tDBSY2 (3rd LPD) may not occur based on the command C/C CMD instructing a corresponding non-volatile memory to simultaneously perform a dumping operation and a program operation.

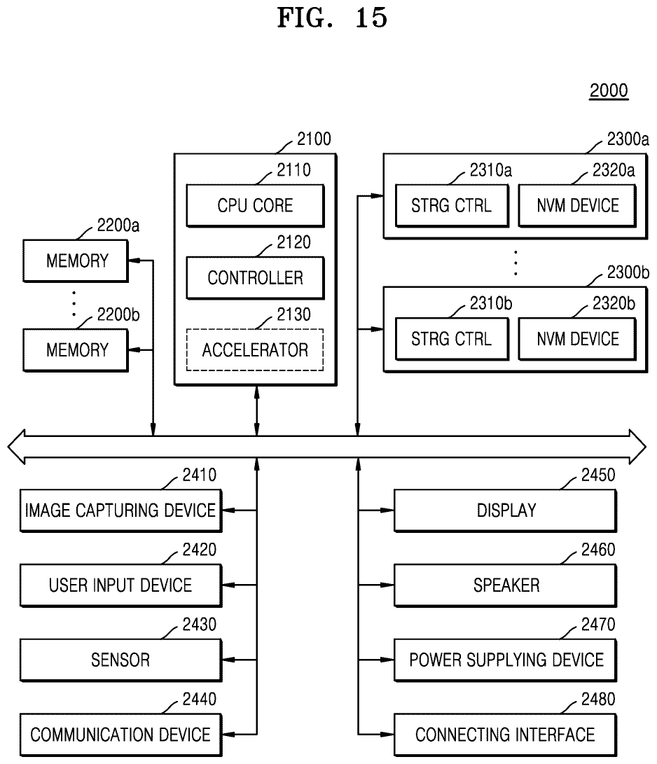

FIG. 15 illustrates a system 2000 to which a storage device according to an embodiment is applied.

The system 2000 of FIG. 15 may fundamentally be a mobile system such as a mobile phone, a smartphone, a tablet personal computer (PC), a wearable device, a healthcare device, or an Internet of things (IOT) device. However, the system 2000 of FIG. 15 is not limited to the mobile system and may be an automotive device such as a PC, a laptop computer, a server, a media player, or a navigation device. Referring to FIG. 15, the system 2000 may include a main processor 2100, memories 2200a and 2200b, and storage devices 2300a and 2300b, and moreover, may additionally include one of an image capturing device 2410, a user input device 2420, a sensor 2430, a communication device 2440, a display 2450, a speaker 2460, a power supplying device 2470, and a connecting interface 2480.

The main processor 2100 may control an overall operation of the system 2000, and in more detail, may control operations of the other elements configuring the system 2000. The main processor 2100 may be implemented as a general-purpose processor, a dedicated processor, or an application processor. The main processor 2100 may include one or more central processing unit (CPU) cores 2110 and may further include a controller 2120 for controlling the memories 2200a and 2200b and/or the storage devices 2300a and 2300b. According to an embodiment, the main processor 2100 may further include an accelerator 2130 which is a dedicated circuit for a high speed data operation such as an artificial intelligence (AI) data operation. The accelerator 2130 may include a graphics processing unit (GPU), a neural processing unit (NPU), and/or a data processing unit (DPU) and may be implemented as a separate chip which is physically independent of the other elements of the main processor 2100.

The memories 2300a and 2300b may be used as a main memory device of the system 2000 and may include a volatile memory such as SRAM and/or DRAM, or may include a non-volatile memory such as flash memory, PRAM, and/or RRAM. The memories 2300a and 2300b may be implemented in the same package as the main processor 2100.

The storage devices 2300a and 2300b may function as a non-volatile storage device which stores data regardless of the supply of power and may have a storage capacity which is relatively greater than the memories 2300a and 2300b. The storage devices 2300a and 2300b may respectively include storage controllers 2310a and 2310b and non-volatile memory devices 2320a and 2320b which store data, based on control by the storage controllers 2310a and 2310b. The non-volatile memory devices 2320a and 2320b may include a flash memory of a two-dimensional (2D) structure or a 3D vertical NAND (VNAND) structure, or may include another kind of non-volatile memory such as PRAM and/or RRAM.

The storage devices 2300a and 2300b may be included in the system 2000 with being physically separated from the main processor 2100, or may be implemented in the same package as the main processor 2100. Moreover, the storage devices 2300a and 2300b may have a type such as an SSD or a memory card. That is, they may be detachably connected to the other elements of the system 2000 through an interface such as the below-described connecting interface 2480. The storage devices 2300a and 2300b may be devices to which standard such as UFS, eMMC, or non-volatile memory express (NVMe) is applied. The embodiments described above with reference to FIGS. 1 to 14 may be implemented in the storage devices 2300a and 2300b.

In some embodiments, as described above with reference to FIGS. 1 to 14, the storage devices 2300a and 2300b may perform an interleave operation by units of one piece of logical page data. This decreases undesired overhead (for example, a period tDBSY2 of FIGS. 10A and 10B), and improves input/output efficiency. Accordingly, a total processing speed of the system 2000 may be enhanced.

The image capturing device 2410 may capture a still image or a moving image and may be a camera, a camcorder, and/or a webcam. The user input device 2420 may receive data of various types input from a user of the system 2000 and may be a touch pad, a keypad, a keyboard, a mouse, and/or a microphone. The sensor 2430 may sense the physical amount of various types capable of being obtained from the outside of the system 2000 and may convert the sensed physical amount into an electrical signal. The sensor 2430 may be a temperature sensor, a pressure sensor, an illumination sensor, a position sensor, an acceleration sensor, a biosensor, and/or a gyroscope sensor.

The communication device 2440 may perform transmission and reception of a signal between other devices outside the system 2000, based on various communication standards. The communication device 2440 may be implemented to include an antenna, a transceiver, and/or a modem. The display 2450 and the speaker 2460 may function as an output device which outputs visual information and acoustic information to the user of the system 2000. The power supplying device 2470 may appropriately transform power supplied from a battery embedded in the system 2000 and/or an external power source to supply to the elements of the system 2000. The connecting interface 2480 may provide a connection between the system 2000 and an external device which is connected to the system 2000 and transmits or receives data to or from the system 2000.

Hereinabove, exemplary embodiments have been described in the drawings and the specification. Embodiments have been described by using the terms described herein, but this has been merely used for describing the present disclosure and has not been used for limiting a meaning or limiting the scope of the present disclosure defined in the following claims. Therefore, it may be understood by those of ordinary skill in the art that various modifications and other equivalent embodiments may be implemented from the present disclosure. Accordingly, the spirit and scope of the present disclosure may be defined based on the spirit and scope of the following claims.

While the present disclosure has been particularly shown and described with reference to embodiments thereof, it will be understood that various changes in form and details may be made therein without departing from the spirit and scope of the following claims.

What is claimed is:

1. A storage device comprising:
a storage controller; and
a plurality of non-volatile memories,
wherein the plurality of non-volatile memories comprise a first non-volatile memory and a second non-volatile memory, the first non-volatile memory and the second non-volatile memory each connected to the storage controller through a channel,
wherein the storage controller is configured to:
transfer first logical page data of first page data to the first non-volatile memory through the channel while performing a program operation of page data comprising a plurality of pieces of logical page data, and
transfer first logical page data of second page data to the second non-volatile memory through the channel while the first logical page data of the first page data from a cache latch of the first non-volatile memory is being dumped into a data latch of the first non-volatile memory.

2. The storage device of claim 1, wherein each of the plurality of non-volatile memories comprises a plurality of memory cell planes, and
wherein the storage controller is further configured to:
sequentially transfer the first logical page data of the first page data to memory cell planes included in the first non-volatile memory through the channel, and
sequentially transfer the first logical page data of the second page data to memory cell planes included in the second non-volatile memory through the channel while the first logical page data of the first page data from a corresponding cache latch is being dumped into a corresponding data latch.

3. The storage device of claim 1, wherein the storage controller is further configured to transfer second logical page data of the first page data to the first non-volatile memory through the channel while the first logical page data of the second page data from a cache latch of the second non-volatile memory is being dumped into a data latch of the second non-volatile memory.

4. The storage device of claim 1, wherein the plurality of non-volatile memories further comprise a third non-volatile memory connected to the storage controller through the channel, and
the storage controller is further configured to:
transfer first logical page data of third page data to the third non-volatile memory through the channel while the first logical page data of the second page data from the cache latch of the second non-volatile memory is being dumped into the data latch of the second non-volatile memory.

5. The storage device of claim 4, wherein the plurality of non-volatile memories further comprise a fourth non-volatile memory connected to the storage controller through the channel, and
the storage controller is further configured to:
transfer second logical page data of the first page data to the first non-volatile memory through the channel while first logical page data of fourth page data from a cache latch of the fourth non-volatile memory is being dumped into a data latch of the fourth non-volatile memory.

6. The storage device of claim 1, wherein the first page data comprises first logical page data, second logical page data, and third logical page data, and
the first non-volatile memory is configured to perform a program operation on the first page data while third logical page data of the first page data from the cache latch of the first non-volatile memory is being dumped into the data latch of the first non-volatile memory.

7. The storage device of claim 6, wherein the first non-volatile memory is configured to perform the program operation of the first page data while the third logical page data of the first page data from the cache latch of the first non-volatile memory is being dumped into the data latch of the first non-volatile memory based on a command of the storage controller, and
a ready and busy signal of the first non-volatile memory is enabled from a time at which the command is received to an end time of the program operation of the first page data.

8. A non-volatile memory device comprising:
a plurality of non-volatile memories,
wherein the plurality of non-volatile memories comprise a first non-volatile memory and a second non-volatile memory, the first non-volatile memory and the second non-volatile memory each connected to a storage controller through channel,
wherein the first non-volatile memory is configured to receive first logical page data of first page data from the storage controller through the channel while performing a program operation of page data comprising a plurality of pieces of logical page data, and
wherein the second non-volatile memory is configured to receive first logical page data of second page data from the storage controller through the channel while the first logical page data of the first page data from a cache latch of the first non-volatile memory is being dumped into a data latch of the first non-volatile memory.

9. The non-volatile memory device of claim 8, wherein each of the plurality of non-volatile memories comprises a plurality of memory cell planes,
wherein memory cell planes included in the first non-volatile memory are configured to sequentially receive the first logical page data of the first page data from the storage controller through the channel, and
wherein memory cell planes included in the second non-volatile memory are configured to sequentially receive the first logical page data of the second page data from the storage controller through the channel while the memory cell planes included in the first non-volatile memory are dumping the first logical page data of the first page data from a corresponding cache latch into a corresponding data latch.

10. The non-volatile memory device of claim 8, wherein the first non-volatile memory is further configured to receive second logical page data of the first page data from the storage controller through the channel while the second non-volatile memory is dumping the first logical page data of the second page data from a cache latch of the second non-volatile memory into a data latch of the second non-volatile memory.

11. The non-volatile memory device of claim 8, wherein the plurality of non-volatile memories further comprise a third non-volatile memory connected to the storage controller through the channel, and
wherein the third non-volatile memory is configured to receive first logical page data of third page data from the storage controller through the channel while the second non-volatile memory is dumping the first logical page data of the second page data from a cache latch of the second non-volatile memory into a data latch of the second non-volatile memory.

12. The non-volatile memory device of claim 11, wherein the plurality of non-volatile memories further comprise a fourth non-volatile memory connected to the storage controller through the channel, and
the first non-volatile memory is further configured to receive second logical page data of the first page data from the storage controller through the channel while the fourth non-volatile memory is dumping first logical page data of fourth page data from a cache latch of the fourth non-volatile memory into a data latch of the fourth non-volatile memory.

13. The non-volatile memory device of claim 8, wherein the first page data comprises first logical page data, second logical page data, and third logical page data, and
the first non-volatile memory is further configured to perform a program operation on the first page data while the first non-volatile memory is dumping third logical page data of the first page data from the cache latch of the first non-volatile memory into the data latch of the first non-volatile memory.

14. The non-volatile memory device of claim 13, wherein the first non-volatile memory is configured to perform the program operation of the first page data while the first non-volatile memory is dumping the third logical page data of the first page data from the cache latch of the first non-volatile memory into the data latch of the first non-volatile memory based on a command of the storage controller, and
a ready and busy signal of the first non-volatile memory is enabled from a time at which the command is received to an end time of the program operation of the first page data.

15. A storage system comprising:
a host configured to output a write request;
a storage controller configured to output a write command based on the write request; and
a non-volatile memory device including a plurality of non-volatile memories and configured to perform a program operation based on the write command,
wherein the plurality of non-volatile memories comprise a first non-volatile memory and a second non-volatile memory, the first non-volatile memory and the second non-volatile memory each connected to the storage controller through channel, and
wherein the storage controller is configured to:
transfer first logical page data of first page data to the first non-volatile memory through the one channel while performing a program operation of page data comprising a plurality of pieces of logical page data, and
transfer first logical page data of second page data to the second non-volatile memory through the channel while the first logical page data of the first page data from a cache latch of the first non-volatile memory is being dumped into a data latch of the first non-volatile memory.

16. The storage system of claim 15, wherein each of the plurality of non-volatile memories comprises a plurality of memory cell planes, and
wherein the storage controller is further configured to:
sequentially transfer the first logical page data of the first page data to memory cell planes included in the first non-volatile memory through the channel, and
sequentially transfer the first logical page data of the second page data to memory cell planes included in the second non-volatile memory through the channel while the first logical page data of the first page data from a corresponding cache latch is being dumped into a corresponding data latch.

17. The storage system of claim 15, wherein the storage controller is further configured to transfer second logical page data of the first page data to the first non-volatile memory through the channel while the first logical page data of the second page data from a cache latch of the second non-volatile memory is being dumped into a data latch of the second non-volatile memory.

18. The storage system of claim 15, wherein the plurality of non-volatile memories further comprise a third non-volatile memory connected to the storage controller through the channel, and
the storage controller is further configured to:
transfer first logical page data of third page data to the third non-volatile memory through the channel while the first logical page data of the second page data from a cache latch of the second non-volatile memory is being dumped into a data latch of the second non-volatile memory.

19. The storage system of claim 15, wherein the plurality of non-volatile memories further comprise a fourth non-volatile memory connected to the storage controller through the channel, and
the storage controller is further configured to:
transfer second logical page data of the first page data to the first non-volatile memory through the channel while first logical page data of fourth page data from a cache latch of the fourth non-volatile memory is being dumped into a data latch of the fourth non-volatile memory.

20. The storage system of claim 15, wherein the first page data comprises first logical page data, second logical page data, and third logical page data, and
the first non-volatile memory is configured to perform a program operation on the first page data while third logical page data of the first page data from the cache latch of the first non-volatile memory is being dumped into the data latch of the first non-volatile memory.
